(19) United States
(12) Patent Application Publication
(10) Pub. No.: US 2012/0177310 A1
(43) Pub. Date: Jul. 12, 2012

(54) CRANKSHAFT SUPPORT STRUCTURE

(75) Inventors: Ryuji TSUCHIYA, Wako-shi (JP); Yutaka INOMOTO, Wako-Shi (JP); Kayoko YAMAZAKI, Wako-shi (JP)

(73) Assignee: HONDA MOTOR CO., LTD.

(21) Appl. No.: 13/339,102

(22) Filed: Dec. 28, 2011

(30) Foreign Application Priority Data
Jan. 6, 2011 (JP) 2011-001079

(51) Int. Cl. F16C 9/02

(52) U.S. Cl. 384/294

(57) ABSTRACT

A crankshaft support structure including a bushing which allows a bearing member to be held firmly on a crankcase, the bearing member supporting a crankshaft rotatably on the crankcase wherein the holding strength of the crankcase for the bushing needs to be increased. The crankcase needs to have a lighter weight and the thermal expansion of the crankcase needs to be prevented from affecting a bearing. An outer circumferential surface of the bushing which is insert-cast in the crankcase has a cylindrical shape, and many small protrusions each having a constricted portion are formed on the outer circumferential surface. Accordingly, the holding strength of the crankcase for the bushing is increased, allowing a small thickness of a bushing holding portion of the crankcase.

### CROSS-REFERENCE TO RELATED APPLICATIONS

The present application claims priority under 35 USC 119 to Japanese Patent Application No. 2011-001079 filed on Jan. 6, 2011 the entire contents of which are hereby incorporated by reference.

### BACKGROUND OF THE INVENTION

1. Field of the Invention

The present invention relates to a crankshaft support structure.

2. Description of Background Art

Light alloy crankcases use bushings in order to increase the strength of a holding portion of bearings supporting a crankshaft in the crankcases.

A cast-iron outer bushing is known that is integrated by enveloped casting with an aluminum-alloy crankcase having a thick bushing holding portion and a steel inner bushing press-fitted in the outer bushing. Moreover, a ball bearing is press-fitted in the inner bushing. The bushings with this construction are held firmly, and the thermal expansion of the crankcase is prevented from affecting the ball bearing. See, for example, Japanese Patent Application Publication No. 2003-184648.

In addition, in another conventional example, a bushing provided with protruding portions, each having a flange portion, in multiple locations on its circumference is integrated by enveloped casting with an aluminum-alloy crankcase to thereby increase the coupling strength between the crankcase and the bushing. See, for example, Japanese Patent Application Publication No. 2010-203581.

The bushing holding portion of the crankcase in a conventional crankcase must have a large thickness in order for the bushing to be held firmly on the crankcase. Thus, the crankcase tends to have a large weight. Moreover, in a case where the thickness of the bushing holding portion is large and the bushing holding strength of the crankcase is large, the thermal expansion of the crankcase affects the ball bearing.

### SUMMARY AND OBJECTS OF THE INVENTION

According to the present invention, the holding strength of a crankcase for a bushing is increased; the crankcase has a smaller weight; and the thermal expansion of the crankcase is prevented from affecting a bearing.

According to an embodiment of the present invention, a crankshaft support structure including a bushing (53) for reinforcing a holding portion where a bearing member (35) is held on a crankcase (20), the bearing member (35) supporting a crankshaft (28) rotatably on the crankcase (20), the crankshaft support structure includes an outer circumferential surface (53a) of the bushing (53) which is insert-cast in the crankcase (20) with a cylindrical shape, and many small protrusions (54) each having a constricted portion (55) are formed on the outer circumferential surface (53a).

According to an embodiment of the present invention, the shape of the bushing (53) before the insert-casting of the crankcase (20) is a bilaterally-symmetrical cylindrical shape.

According to an embodiment of the present invention, a thickness (Tc) of a bushing holding portion (62) of the crankcase (20) is made smaller than a radial thickness (Tb) of the bushing (53).

According to an embodiment of the present invention, a thickness (Tc) of a bushing holding portion (62) of the crankcase (20) is made not larger than ½ of a radial thickness (Tb) of the bushing (53).

According to an embodiment of the present invention, an outer circumferential portion of a lateral surface of the bushing (53) is formed by insert-casting in advance, and after the casting is complete, a step portion (64) for managing a gap to an oil supply plate (63) is formed in the outer circumferential portion of the lateral surface by a machining process.

According to an embodiment of the present invention, the number of cylinders or a crank stroke is appropriately set such that an outside diameter of the bushing (53) is equal to an outside diameter of a cylinder liner (68) of an internal combustion engine.

According to an embodiment of the present invention, a height of each of the protrusions (54) is made to be 0.5 mm to 1.5 mm, and a diameter of a top of the protrusion (54) is made to be 0.5 to 1.0 mm.

According to an embodiment of the present invention, the coupling strength of the casting to the crankcase (20) can be improved.

According to an embodiment of the present invention, no limitation is imposed on the orientation in which the bushing (53) is mounted in a mold at the time of casting. Accordingly, the productivity of the crankcase (20) is improved.

According to an embodiment of the present invention, the coupling strength can be secured even when the radial thickness (Tc) of the bushing holding portion (62) is small. Accordingly, the crankcase (20) can have a smaller weight.

According to an embodiment of the present invention, the thickness of the bushing holding portion (62) is reduced to ½, thereby reducing the force which the thermal expansion of the crankcase (20) exerts on the bushing (53) in the direction of the expansion. This prevents a change in interference (66) between the bushing (53) and the ball bearing (35), and thus maintains a stable bearing gap (67). Accordingly, the durability and quietness of the bearing (35) can be improved.

According to an embodiment of the present invention, after the casting of the lateral portion of the bushing (53) is complete, the step portion (64) for managing the gap to the oil supply plate (63) is formed in the lateral portion by the machining process. Accordingly, the lateral portion can be accurately formed by the machining process.

According to an embodiment of the present invention, a raw material of the cylinder liner (68) on which the many small protrusions (54) having the constricted portions (55) are formed may be created. This raw material can be cut into a circular slice and used as a raw material of the bushing (53). Thus, an apparatus for exclusively casting bushings is no longer needed, improving the productivity. Accordingly, a cost reduction is possible.

According to an embodiment of the present invention, each protrusion (54) is formed into a shape with a limited height and width. Thus, many protrusions (54) can be arranged densely even in a case of a relatively small bushing (53). Accordingly, variations in attachment strength can be prevented, and thereby the coupling strength of the casting can be made stable.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a left-side view of a motorcycle according to an embodiment of the present invention;

FIG. 2 is a left-side view of a vertical cross section of a power unit;

FIG. 3 is a cross-sectional view taken along the line of FIG. 2;

FIG. 4 is a perspective view of a bushing;

FIG. 5 is an enlarged, partially cutaway perspective view of the bushing;

FIGS. 6(a) to 6(h) are diagrams showing a process of manufacturing of the bushing having small protrusions and a process of enveloped casting with a crankcase;

FIG. 7 is a cross-sectional view of the bushing manufactured by the above method;

FIG. 8 is a partial cross-sectional view of an aluminum-alloy crankcase enveloping the bushing;

FIG. 9 is a partial cross-sectional view of the crankcase after the enveloped bushing is machined;

FIG. 10 is a view showing a state where a ball bearing is press-fitted in the bushing having undergone the above machining processes; and

FIG. 11 is a perspective view of an iron casting raw material of a cylinder liner according to a second embodiment of the present invention.

### DETAILED DESCRIPTION OF THE PREFERRED EMBODIMENTS

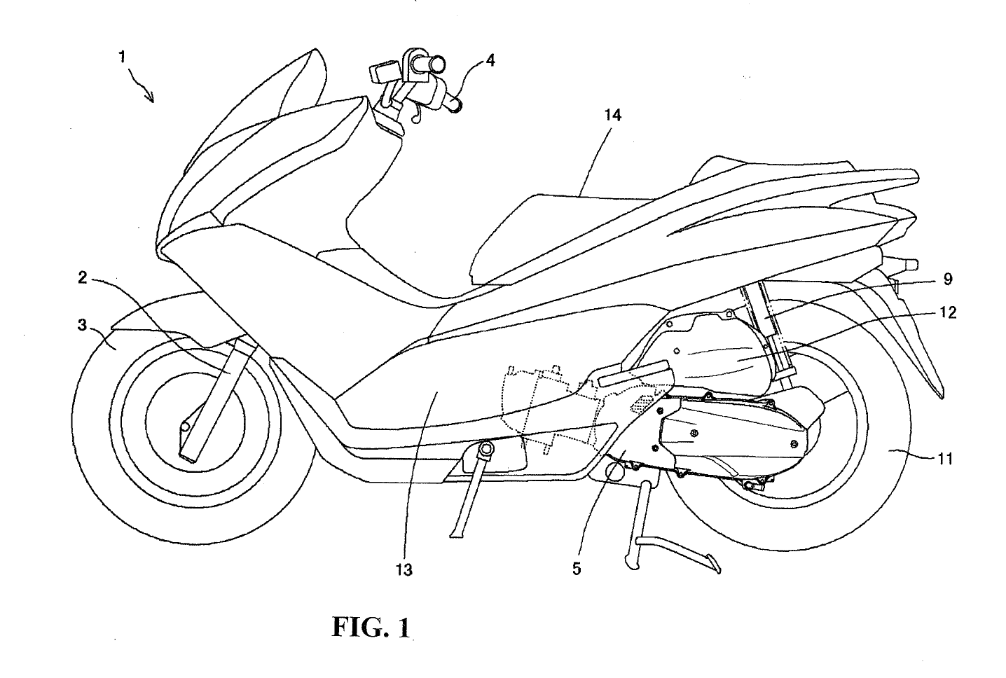

FIG. 1 is a left-side view of a motorcycle 1 according to an embodiment of the present invention. The body frame of this motorcycle 1 is formed of a head pipe; a main frame extending downwardly toward the rear from the head pipe; a pair of left and right rear frames each extending upward toward the rear and having one end connected to a rear portion of the main frame; and other multiple frames. A front wheel 3 is supported about its axis on each lower end of a front folk 2 which is rotatably supported on the head pipe. A steering bar 4 is joined to an upper portion of the front folk 2.

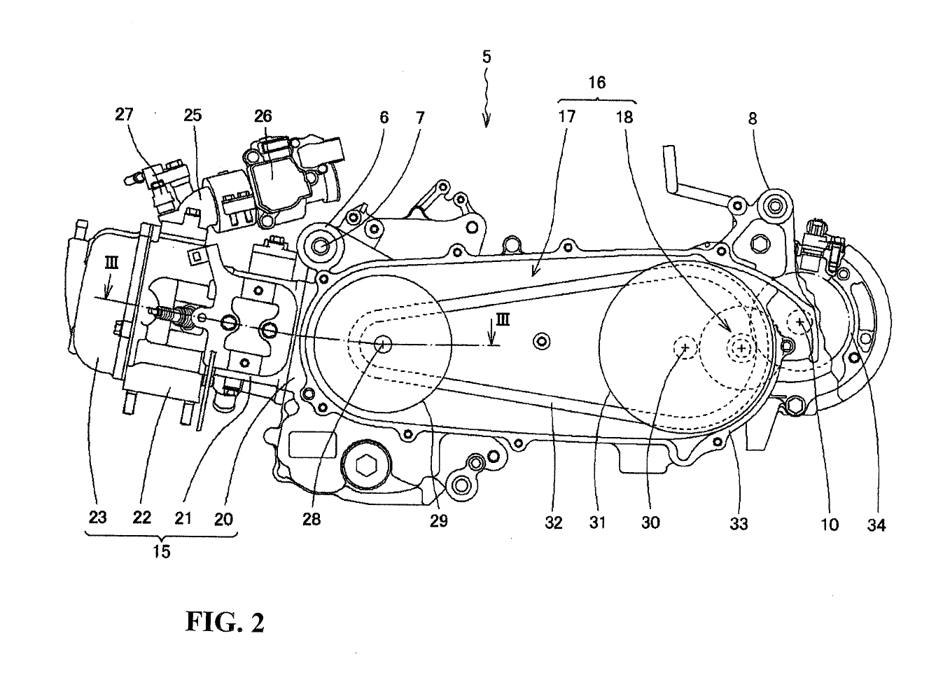

A power unit 5 of this motorcycle 1 is hung across power-unit hanging brackets (unillustrated) provided to the rear frames, through a hanger 6 (FIG. 2) formed integrally with a front portion of the power unit 5 and also through a support shaft 7 (FIG. 2). A rear shock absorber 9 is provided between a bracket 8 (FIG. 2) provided on a rear end portion of the power unit 5 and a bracket (unillustrated) on a rear portion of one of the rear frames. Thus, the power unit 5 is swingably hung with the axis of the cylinder oriented slightly upwardly. A rear wheel 11 (FIG. 1) is attached to a rear axle 10 (FIG. 2) projecting to the right from a rear portion of the power unit 5 and is driven by the power unit 5. An air cleaner 12 is provided above the power unit 5. A synthetic-resin body cover 13 formed of multiple parts is attached to the body frame, covering the power unit and other devices. A tandem seat 14 is provided on an upper portion of the body.

FIG. 2 is a left-side view of a vertical cross section of the power unit 5. The power unit 5 is formed of an internal combustion engine 15 given at a front side and a transmission device 16 extending rearwardly from a left side of the internal combustion engine 15. The transmission device 16 is formed of a V-belt type continuously variable transmission 17 and a gear reducer 18.

The shell of the internal combustion engine 15 is formed of a crankcase 20, as well as a cylinder block 21, a cylinder head 22, and a cylinder-head cover 23 which are coupled to a front portion of the crankcase 20 from the front in this order. The internal combustion engine 15 is a rocker-arm type, overhead-valve, four-stroke-cycle, single-cylinder, water-cooled internal combustion engine. A throttle body 26 is attached to an inlet pipe 25 attached to an intake port in an upper side of the cylinder head 22. Further, a rear side of the throttle body 26 is connected to the air cleaner 12 (FIG. 1). A fuel injection valve 27 is attached to the inlet pipe 25.

The left half of the power unit 5 in FIG. 2 is provided with the V-belt type continuously variable transmission 17. The drive shaft of the V-belt type continuously variable transmission 17 is the same as a crankshaft 28 of the internal combustion engine 15, and a drive pulley 29 of the V-belt type continuously variable transmission 17 is provided at a left extended portion of the crankshaft 28. A driven shaft 30 of the V-belt type continuously variable transmission 17 is rotatably supported on a transmission case 33 through a bearing. This driven shaft 30 is provided with a driven pulley 31 with a centrifugal clutch in between. An endless V belt 32 is laid between the drive pulley 29 and the driven pulley 31.

The gear reducer 18 is provided in a rear part of the V-belt type continuously variable transmission 17. The input shaft of the gear reducer 18 is the same as the driven shaft 30. The rear axle 10 having the rear wheel 11 (FIG. 1) coupled integrally therewith is rotatably supported on the transmission case 33 and a gear case 34. The torque of the driven shaft 30 is transmitted to the rear axle 10 through multiple gears. The acceleration of the rear axle 10 is reduced greatly from that of the driven shaft 30, and the rear wheel 11 coupled to the rear axle 10 is driven at the reduced speed.

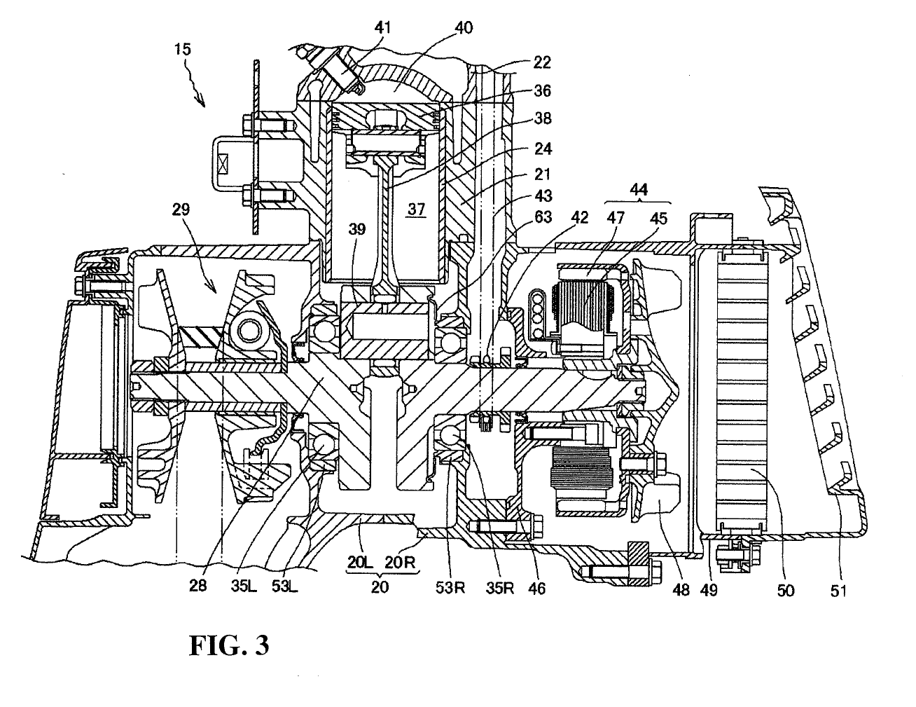

FIG. 3 is a cross-sectional view taken along the III-III line of FIG. 2. In FIG. 3, the shell of the internal combustion engine 15 is formed of the crankcase 20, as well as the cylinder block 21, the cylinder head 22, and the cylinder-head cover 23 (FIG. 2) which are coupled to a front portion of the crankcase 20 from the front in this order. The crankcase 20 has a left-right halved structure and is formed of a left crankcase 20L and a right crankcase 20R.

The crankshaft 28 is rotatably supported by a left ball bearing 35L and a right ball bearing 35R which are supported on the crankcase 20L and the crankcase 20R, respectively. A piston 36 is slidably fitted in a cylinder bore 37 formed in a cylinder liner 24 provided inside the cylinder block 21. The piston 36 is connected to a crankpin 39 of the crankshaft 28 by a connecting rod 38. Reciprocating the piston 36 will rotationally drive the crankshaft 28. A combustion chamber 40 facing the upper surface of the piston 36 is formed at the bottom of the cylinder head 22A. A spark plug 41 is mounted to the cylinder head 22 at such a posture as to tilt leftward from the center axis of the cylinder bore 37.

The drive pulley 29 of the V-belt type continuously variable transmission 17 is provided at the left extended portion of the crankshaft 28. A cam-chain drive sprocket 42 is formed adjacent to the right ball bearing 35R of the crankshaft 28, and has a cam chain 43 wound therearound.

An AC generator 44 is provided at a right extended portion of the crankshaft 28. An AC-generator stator 45 is attached and fixed to an AC-generator attachment 46 attached to the right crankcase 20R. An AC-generator rotor 47 is fixed to the right end of the crankshaft 28 and rotates together with the crankshaft 28. A centrifugal-radiator cooling fan 48 is provided on a right side of the AC-generator rotor 47. A radiator 50 is attached to a right side of the centrifugal-radiator cooling fan 48 with a radiator holding member 49 therebetween. A right side of the radiator 50 is covered with a radiator cover 51 having cooling air passages therein.

In FIG. 3, the ball bearings 35L and 35R supporting the crankshaft 28 are held on the crankcases 20L and 20R with bushings 53L and 53R therebetween, respectively. The bushings 53L and 53R are made of cast iron and are subjected to enveloped casting at the time of casting the aluminum-alloy crankcases 20L and 20R. The ball bearings 35L and 35R are press-fitted in the enveloped bushings 53L and 53R, respectively.

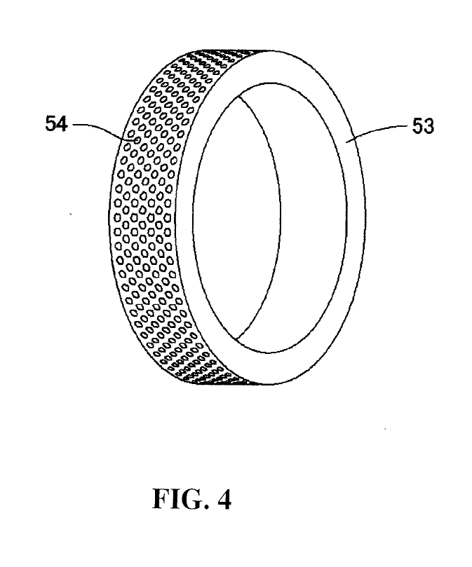

FIG. 4 is a perspective view of the bushing 53. The left bushing 53L, the left ball bearing 35L, and a bushing holding portion of the left crankcase 20L have substantially the same shapes as those of the right bushing 53R, the right ball bearing 35R, and the bushing holding portion of the right crankcase 20R, respectively. In the following description, the left and right parts do not need to be distinguished and therefore will not be distinguished, and L and R shown in their reference signs will be omitted. In FIG. 4, the bushing 53 has many small protrusions 54 formed on its cylindrical outer circumferential surface. The dimensions of and pitches between the protrusions 54 are uneven.

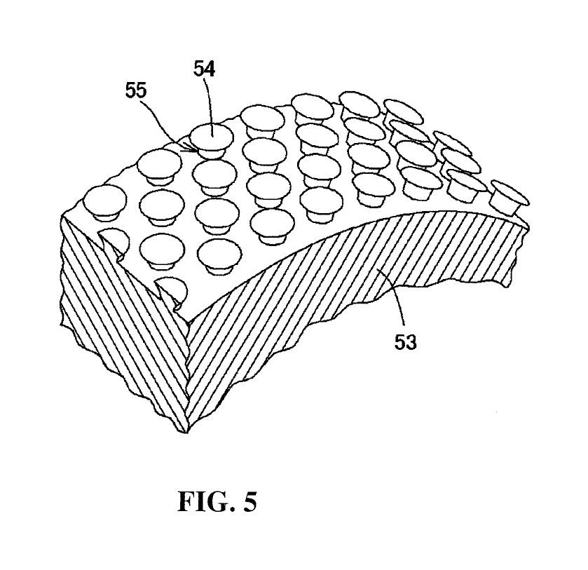

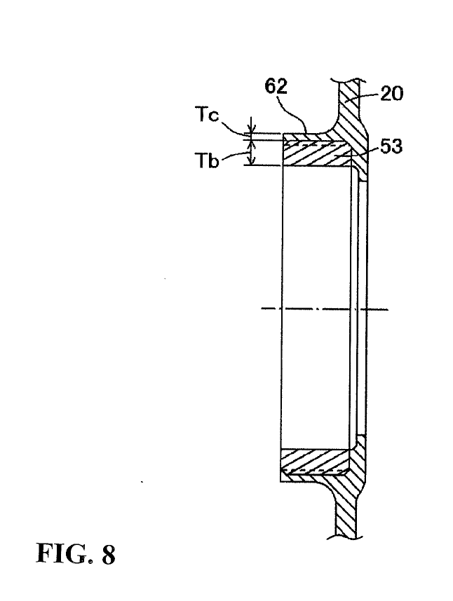

FIG. 5 is an enlarged, partially cutaway perspective view of the bushing 53. The many protrusions 54 formed on the outer circumferential surface of the bushing 53 are each formed to include a constricted portion 55. As the bushing 53 undergoes enveloped casting at the time of manufacturing the crankcase 20, an aluminum-alloy melt is introduced between the protrusions 54, and thereby the crankcase 20 and the bushing 53 are coupled integrally with each other. The constricted portions 55 act to increase the coupling strength of the casting, and thereby allow a reduction in the thickness of a bushing holding portion 62 (FIGS. 8 to 10) of the crankcase 2. Accordingly, the crankcase 20 can have a lighter weight.

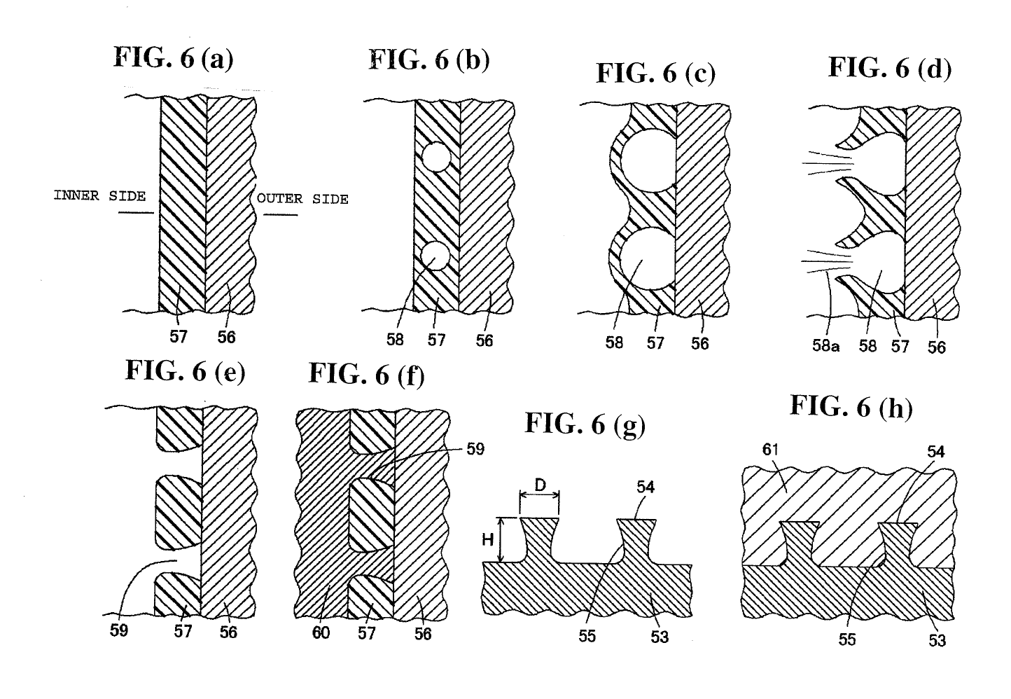

FIGS. 6(a) to 6(h) are diagrams showing a process of manufacturing of the bushing 53 having the protrusions 54 and a process of insert-casting with the crankcase 20. Manufacturing steps will be sequentially described using this diagram.

FIG. 6(a) A mold 56 (die) constituting a centrifugal casting machine and having a cylindrical inner circumferential surface is supported rotatable about the axis of a cylindrical shaft inside the cylindrical space. This mold 56 includes a rotationally drive part. A facing 57 is applied on the inner circumferential surface of the mold 56 while rotating the mold 56 at a centrifugal acceleration of 25 G to 35 G by using the drive part. This facing 57 is a suspension in which diatomite, bentonite, a release agent, a surfactant, and water are mixed in a predetermined ratio, for example, and is applied into a thickness of 1.0 to 1.5 mm.

FIG. 6(b) Bubbles 58 are generated inside the coating of the facing 57.

FIG. 6(c) The bubbles 58 grow gradually. The far side of each bubble 58 comes into contact with the mold by the pressure of the bubble 58. The facing 57 is pushed at the inner surface by the pressures of the bubbles 58 and therefore swollen.

FIG. 6(d) As the bubbles 58 grow further, the portions of the facing 57 pushed and swollen by the bubbles 58 break, and air 58a jets therefrom.

FIG. 6(e) Once the jetting ends, the facing 57 pushed and stretched by the bubbles tries to contract and return to its original shape. However, since the solidification of the facing 57 has already started, the portions having had the bubbles 58 remain inside the facing 57 as small cavities, and the jetting holes remain unclosed against the effect of the contraction of the facing 57. As a result, the cavities become small recessed holes 59.

FIG. 6(f) After the facing 57 is solidified, the atmosphere inside the mold 56 is replaced with an atmosphere of an inert gas such as argon gas. Then, a cast-iron melt 60 which will become a bushing is introduced into the mold 56 while rotating the mold 56 at a centrifugal acceleration of 100 G to 135 G The cast-iron melt 60 enters and fills the recessed holes 59 in the facing.

FIG. 6(g) After the cast-iron melt 60 is solidified, the mold 56 is removed, and blasting is performed to remove the facing 57, whereby a bushing 53 is taken out as a raw material. On the outer circumferential surface of the bushing 53, the shapes of the recessed holes 59 in the facing 57 are transferred, forming many protrusions 54. A height H of each protrusion 54 is made to be 0.5 to 1.5 mm. A diameter D of the top of the protrusion 54 is made to be 0.5 to 1.0 mm. Each individual protrusion 54 has a shape including a constricted portion 55. With this bushing 53 held by a clamp mechanism, the inner circumferential surface and both side surfaces thereof are subjected to machine finishing and both corners of the outer circumferential surface are subjected to chamfering.

FIG. 6(h) The bushing 53 subjected to the above processes is placed inside a crankcase-casting mold, and an aluminum-alloy melt 61 is introduced into this mold. Once the aluminum-alloy melt 61 is solidified, there is obtained a crankcase 20 enveloping the bushing therein. The aluminum-alloy melt 61 enters between the protrusions 54 having the constricted portions 55 and solidifies there. Accordingly, the bushing 53 is held firmly on the formed crankcase 20.

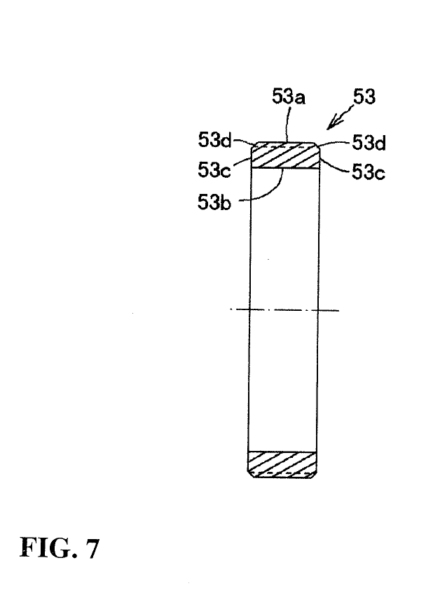

FIG. 7 is a cross-sectional view of the bushing 53 manufactured by the above method. The above-mentioned many protrusions 54 are formed on an outer circumferential surface 53a of the bush. An inner circumferential surface 53b and both side surfaces 53c of the bushing are subjected to machine finishing, and both corners of the outer circumferential surface 53a are subjected to chamfering 53d. The shape of the bushing 53 described above is a shape before the insert-casting of the crankcase 20, which is bilaterally symmetrically cylindrical. Thus, no limitation is imposed on the orientation in which the bushing 53 is mounted in the die at the time of casting the crankcase. Accordingly, the productivity of the crankcase 20 is improved.

FIG. 8 is a partial cross-sectional view of the aluminum-alloy crankcase 20 enveloping the bushing 53. Since the aluminum-alloy melt 61 enters the portions around the many protrusions 54 on the outer circumferential surface 53a of the bush, the coupling strength of the casting between the bushing 53 and the crankcase 20 is improved. A radial thickness Tc of the bushing holding portion 62 of the crankcase 20 is made smaller than a radial thickness Tb of the bushing 53. To secure the coupling strength, the radial thickness of the bushing holding portion 62 is made large in conventional practices. With the above-described bushing 53, however, the coupling strength can be secured even when the radial thickness Tc of the bushing holding portion 62 of the crankcase 20 is small. Accordingly, the crankcase 20 can have a smaller weight.

In addition, the thickness of the bushing holding portion 62 is reduced to ½ in a case where the radial thickness Tc of the bushing holding portion 62 of the crankcase 20 is made not larger than ½ of the radial thickness Tb of the bushing 53. Such reduction can reduce the force which the thermal expansion of the crankcase 20 exerts on the bushing in the direction of the expansion.

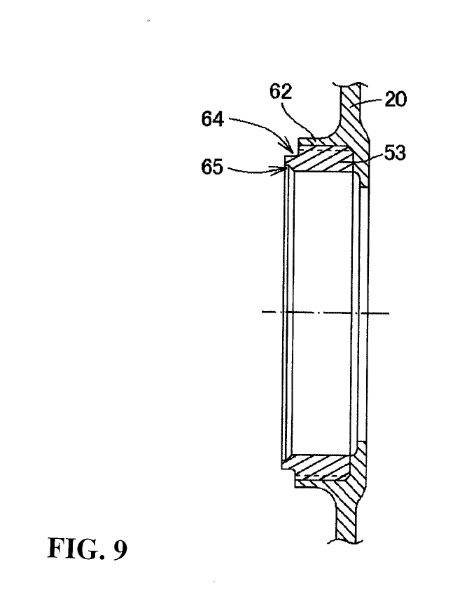

FIG. 9 is a partial cross-sectional view of the crankcase 20 after the enveloped bushing 53 is machined. In the state where the bushing 53 is enveloped, a gap-management step portion 64 facing an oil supply plate 63 (FIG. 3) is formed by a machining process. Moreover, an inclined entrance surface 65 is formed in a ball-bearing insertion portion by a cutting process so that the ball bearing 35 can be inserted easily when press-fitted. The gap-management step portion 64 facing the oil supply plate 63 is formed after the casting of the crankcase 20. Accordingly, easiness in casting the crankcase 20 can be improved, and a precise distance can be achieved between the gap-management step portion 64 and the oil supply plate 63.

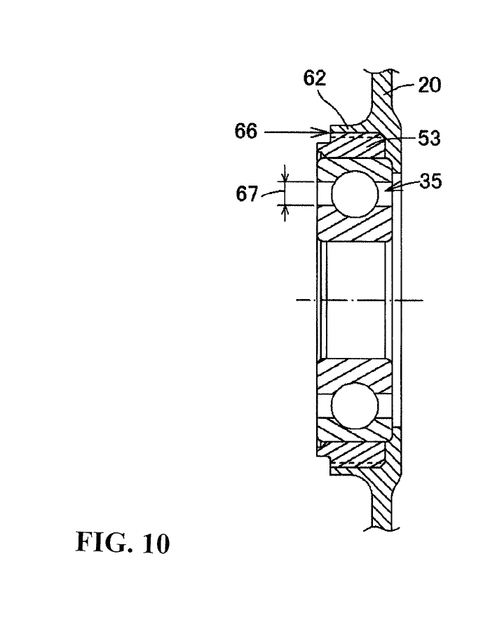

FIG. 10 is a view showing a state where the ball bearing 35 is press-fitted in the bushing 53 having undergone the above machining processes. The many small protrusions 54 having the constricted portions 55 are formed on the bushing 53 of the embodiment described above. Thus, the coupling strength is large even when the bushing holding portion 62 of the crankcase 20 is made thin. Even when the crankcase 20 is stretched radially outward due its thermal expansion, the force exerted on the bushing 53 in the direction of the expansion can be reduced since the thickness of the bushing holding portion 62 is reduced to ½. This prevents a change in interference 66 between the bushing 53 and the ball bearing 35 attributable to the thermal expansion of the crankcase 20, and thus maintains a stable bearing gap 67. Accordingly, the durability of the ball bearing 35 can be improved.

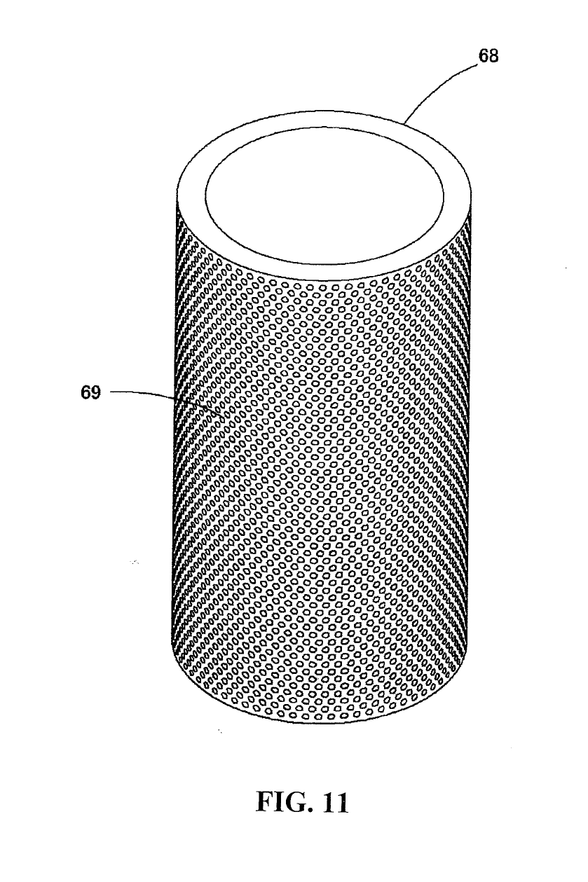

FIG. 11 is a perspective view of an iron casting raw material of a cylinder liner 68 according to a second embodiment of the present invention. FIG. 11 is a view of a raw material of the cylinder liner 68 which is used in an internal combustion engine designed by setting, in the design phase, the number of cylinders or a crank stroke is appropriately set such that the outside diameter of the bushing 53 and the outside diameter of the cylinder liner 68 can be equal. Many protrusions 69 each having a constricted portion are provided on the outer circumferential surface of the cylinder liner 68 by the same manufacturing method as that of the first embodiment. When a bushing 53 is needed, the raw material of the cylinder liner 68 can be cut into a circular slice and used as the bushing 53. Thus, an apparatus for exclusively casting bushings is no longer needed, improving the productivity. Accordingly, a cost reduction is possible.

In the bushing of each embodiment described above, each protrusion 54 is formed into a shape with a limited height and width by setting the height of the protrusion 54 is made to be 0.5 mm to 1.5 mm and the diameter of the top of the protrusion 54 is made to be 0.5 to 1.0 mm. Thus, many protrusions 54 can be arranged densely even in a case of a relatively small bushing 53. Accordingly, variations in attachment can be prevented, and thereby the coupling strength of casting can be made stable.

As described above in detail, the embodiments provide the following advantageous effects.

(1) The bushing 53 includes the many small protrusions 54 each having the constricted portion 55. Thus, the coupling strength of the casting to the crankcase 20 can be improved.

(2) The bushing 53 before the insert-casting of the crankcase 20 has a bilaterally symmetrical cylindrical shape. Thus, no limitation is imposed on the orientation in which the bushing 53 is mounted in a mold at the time of casting. Accordingly, the productivity of the crankcase 20 is improved.

(3) The coupling strength between the crankcase 20 and the bushing 53 can be secured. Thus, the crankcase 20 can have a smaller weight with a small radial thickness Tc of the bushing holding portion 62.

(4) The bushing holding portion 62 is capable of elastic deformation in a case where the thickness of the bushing holding portion 62 of the crankcase 20 is made not larger than ½ of the radial thickness Tb of the bushing 53. This can reduce the force which the thermal expansion of the crankcase 20 exerts on the bushing 53 in the direction of the expansion. This prevents a change in interference 66 between the bushing 53 and the ball bearing 35, and thus maintains a stable bearing gap 67. Accordingly, the durability of the ball bearing 35 can be improved.

(5) After the casting is complete, the step portion 64 for managing the gap to the oil supply plate 63 is formed by the machining process. Accordingly, the lateral portion can be accurately formed by the machining process.

(6) When the outside diameter of the bushing 53 and the outside diameter of the cylinder liner 68 is made equal, a raw material of the cylinder liner (68) on which the many small protrusions (54) having the constricted portions (55) are formed may be created, and this raw material can be cut into a circular slice and used as a raw material of the bushing (53). Thus, an apparatus for exclusively casting bushings is no longer needed, improving the productivity. Accordingly, cost reduction is possible.

(7) The height of each protrusion 54 is made to be 0.5 to 1.5 mm. The diameter of the top of the protrusion 54 is made to be 0.5 to 1.0 mm. Thus, the coupling strength of the casting can be made stable with a relatively small bushing 53.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A crankshaft support structure comprising:
a bushing for reinforcing a holding portion adjacent to the positioning of a bearing member held on a crankcase, the bearing member supporting a crankshaft rotatably on the crankcase;
an outer circumferential surface of the bushing being insert-cast in the crankcase and having a cylindrical shape, and
many small protrusions each having a constricted portion are formed on the outer circumferential surface.

2. The crankshaft support structure according to claim 1, wherein a shape of the bushing before the insert-casting of the crankcase is a bilaterally-symmetrical cylindrical shape.

3. The crankshaft support structure according to claim 1, wherein a thickness of a bushing holding portion of the crankcase is made smaller than a radial thickness of the bushing.

4. The crankshaft support structure according to claim 1, wherein a thickness of a bushing holding portion of the crankcase is made not larger than ½ of a radial thickness of the bushing.

5. The crankshaft support structure according to claim 2, wherein a thickness of a bushing holding portion of the crankcase is made not larger than ½ of a radial thickness of the bushing.

6. The crankshaft support structure according to claim 3, wherein a thickness of a bushing holding portion of the crankcase is made not larger than ½ of a radial thickness of the bushing.

7. The crankshaft support structure according to claim 4, wherein
an outer circumferential portion of a lateral surface of the bushing is formed by insert-casting in advance, and
after the casting is complete, a step portion for managing a gap to an oil supply plate is formed in the outer circumferential portion of the lateral surface by a machining process.

8. The crankshaft support structure according to claim 5, wherein
an outer circumferential portion of a lateral surface of the bushing is formed by insert-casting in advance, and
after the casting is complete, a step portion for managing a gap to an oil supply plate is formed in the outer circumferential portion of the lateral surface by a machining process.

9. The crankshaft support structure according to claim 2, wherein the number of cylinders or a crank stroke is appropriately set such that an outside diameter of the bushing is equal to an outside diameter of a cylinder liner of an internal combustion engine.

10. The crankshaft support structure according to claim 1, wherein a height of each of the protrusions is made to be 0.5 mm to 1.5 mm, and
a diameter of a top of the protrusion is made to be 0.5 to 1.0 mm.

11. A bushing adapted for use with a crankshaft support structure comprising an outer circumferential surface of the bushing being insert-cast in the crankcase and having a substantially cylindrical shape with a plurality of small protrusions projecting from an outer surface of the substantially cylindrical shape each of the plurality of protrusions having a constricted portion formed on the outer circumferential surface for increasing the coupling strength of the bushing to the crankshaft.

12. The bushing adapted for use with a crankshaft support structure according to claim 11, wherein a shape of the bushing before the insert-casting of the crankcase is a bilaterally-symmetrical cylindrical shape.

13. The bushing adapted for use with a crankshaft support structure according to claim 11, wherein a thickness of a bushing holding portion of the crankcase is made smaller than a radial thickness of the bushing.

14. The bushing adapted for use with a crankshaft support structure according to claim 11, wherein a thickness of a bushing holding portion of the crankcase is made not larger than ½ of a radial thickness of the bushing.

15. The bushing adapted for use with a crankshaft support structure according to claim 12, wherein a thickness of a bushing holding portion of the crankcase is made not larger than ½ of a radial thickness of the bushing.

16. The bushing adapted for use with a crankshaft support structure according to claim 13, wherein a thickness of a bushing holding portion of the crankcase is made not larger than ½ of a radial thickness of the bushing.

17. The bushing adapted for use with a crankshaft support structure according to claim 14, wherein
an outer circumferential portion of a lateral surface of the bushing is formed by insert-casting in advance, and
after the casting is complete, a step portion for managing a gap to an oil supply plate is formed in the outer circumferential portion of the lateral surface by a machining process.

18. The bushing adapted for use with a crankshaft support structure according to claim 15, wherein
an outer circumferential portion of a lateral surface of the bushing is formed by insert-casting in advance, and
after the casting is complete, a step portion for managing a gap to an oil supply plate is formed in the outer circumferential portion of the lateral surface by a machining process.

19. The bushing adapted for use with a crankshaft support structure according to claim 12, wherein the number of cylinders or a crank stroke is appropriately set such that an outside diameter of the bushing is equal to an outside diameter of a cylinder liner of an internal combustion engine.

20. The bushing adapted for use with a crankshaft support structure according to claim 11, wherein a height of each of the protrusions is made to be 0.5 mm to 1.5 mm, and
a diameter of a top of the protrusion is made to be 0.5 to 1.0 mm.
